(19) United States
(12) Patent Application Publication
(10) Pub. No.: US 2007/0096621 A1
(43) Pub. Date: May 3, 2007

(54) Electron emission display

(76) Inventors: Sang-Ho Jeon, Suwon-si (KR); Chun-Gyoo Lee, Suwon-si (KR); Sang-Jo Lee, Suwon-si (KR); Sang-Hyuck Ahn, Suwon-si (KR); Su-Bong Hong, Suwon-si (KR); Jong-Hoon Shin, Suwon-si (KR)

Correspondence Address: Robert E. Bushnell, Suite 300, 1522 K Street, N.W., Washington, DC, 20005, US

(21) Appl. No.: 11/585,845

(22) Filed: Oct. 25, 2006

(30) Foreign Application Priority Data
Oct. 31, 2005 (KR) 10-2005-0103514
Dec. 30, 2005 (KR) 10-2005-0135164

(51) Int. Cl. H01J 1/62; H01J 63/04; H01J 1/00

(52) U.S. Cl. 313/495; 313/311; 313/310

(57) ABSTRACT

An electron emission display includes first and second substrates facing each other, first electrodes formed on the first substrate, and electron emission regions electrically connected to the first electrodes. Second electrodes are placed over the first electrodes such that the second electrodes are electrically insulated from the first electrodes. The second electrodes have a plurality of openings for exposing the electron emission regions. A third electrode is placed over the second electrodes such that the third electrode is electrically insulated from the second electrodes. The third electrode has openings communicating with the openings of the second electrodes. The second and the third electrodes are structured to satisfy the following condition: 1.5≦W2/W1≦3.0 where W1 indicates the width of each opening of the second electrodes, and W2 indicates the width of the opening of the third electrode.

### CROSS REFERENCES TO RELATED APPLICATION AND CLAIM OF PRIORITY

The present application claims priority to and the benefit of Korean Patent Applications No. 10-2005-0103514 filed on Oct. 31, 2005 and No. 10-2005-0135164 filed on Dec. 30, 2005, in the Korean Intellectual Property Office, the entire contents of both of which are incorporated herein by reference.

### BACKGROUND OF THE INVENTION

(a) Field of the Invention

The present invention relates to an electron emission display, and in particular, to an electron emission display which has a focusing electrode formed over the driving electrodes to focus the electron beams.

(b) Description of the Related Art

Generally, electron emission elements are classified, depending upon the kinds of electron sources, into a first type using a hot cathode, and a second type using a cold cathode.

Among the second typed electron emission elements using a cold cathode are known a field emission array (FEA) type, a surface-conduction emission (SCE) type, a metal-insulator-metal (MIM) type, and a metal-insulator-semiconductor (MIS) type.

The FEA-type electron emission element has electron emission regions, and a cathode and a gate electrode as the driving electrodes. The electron emission regions are formed with a material having a low work function or a high aspect ratio, like a carbonaceous material. In the FEA-type electron emission element with the usage of such a material for the electron emission regions, when an electric field is applied to the electron emission regions under a vacuum atmosphere, electrons are easily emitted from those electron emission regions.

Arrays of the electron emission elements are arranged on a first substrate to form an electron emission unit, and a light emission unit is formed on a surface of a second substrate facing the first substrate with phosphor layers and an anode electrode. The electron emission unit and the light emission unit make formation of an electron emission display.

A focusing electrode may be formed at the electron emission unit to focus the electron beams. The focusing electrode is formed over the driving electrodes while interposing an insulating layer between the focusing electrode and the driving electrodes, and openings are formed at the insulating layer and the focusing electrode to pass the electron beams. The focusing electrode receives 0V or a negative direct current voltage of several to several tens volts, and focuses the electrons passed the openings to the centers of the bundles of electron beams.

With the conventional electron emission display, the trajectories of the electron beams passed the openings of the focusing electrode toward the light emission unit depend upon the opening size characteristics of the focusing electrode.

When the focusing electrode is placed far from the bundles of electron beams emitted from the electron emission regions, the focusing effect is lowered so that the negative direct current voltage applied to the focusing electrode should be heightened. On the contrary, when the focusing electrode is placed too close to the bundles of electron beams emitted from the electron emission regions, the electron beams are rather over-focused so that the spot size of the electron beams landed on the phosphor layers becomes greatened.

Accordingly, it is needed to optimize the opening size of the focusing electrode such that the focusing voltage is maintained to be in an optimum level while maximizing the electron beam focusing capacity.

The electrons emitted from the electron emission regions do not pass the openings of the insulating layer completely, and some of the electrons collide against the sidewall of the openings of the insulating layer to incur the electric charging. The electric charging distorts the trajectories of electron beams, thereby factoring the bundle of electron beams into main beams, and secondary beams placed external to the main beams with an intensity weaker than that of the main beams.

The secondary beams cause an incidental light emission, thereby deteriorating the light emission uniformity of the phosphor layers, and land on the incorrect phosphor layers to excite them, thereby deteriorating the screen color purity.

### SUMMARY OF THE INVENTION

In one exemplary embodiment of the present invention, there is provided an electron emission display which maximizes the electron beam focusing capacity and prevents the secondary electron beams from being generated due to the electric charging of the insulating layer.

According to one exemplary embodiment of the present invention, an electron emission display includes first and second substrates facing each other, first electrodes formed on the first substrate, and electron emission regions electrically connected to the first electrodes. Second electrodes are placed over the first electrodes and are electrically insulated from the first electrodes. The second electrodes have a plurality of openings for exposing the electron emission regions. A third electrode is placed over the second electrodes and is electrically insulated from the second electrodes. The third electrode has openings communicating with the openings of the second electrodes. Phosphor layers are placed on one surface of the second substrate. A fourth electrode is placed on one surface of the phosphor layers. The second and the third electrodes are structured to satisfy the following condition:
1.5≦W2/W1≦3.0 (1)

where W1 indicates the width of each opening of the second electrodes, and W2 indicates the width of each opening of the third electrode.

The phosphor layers may have red, green and blue phosphor layers arranged in a direction of the substrates neighboring to each other, and the widths of W1 and W2 may be measured in the direction of the substrates.

The first and the second electrodes may cross each other, the electron emission regions, the openings of the second electrodes and the openings of the third electrode may be arranged at the crossed regions of the first and the second electrodes, and the respective openings of the second electrodes at each crossed region are arranged in a row in the longitudinal direction of the first electrodes.

Each one of the openings of the third electrode may be arranged at the respective crossed regions, or over the respective openings of the second electrodes.

According to another exemplary embodiment the present invention, an electron emission display includes first and second substrates facing each other, first electrodes formed on the first substrate, electron emission regions electrically connected to the first electrodes, and second electrodes placed over the first electrodes and the second electrodes are electrically insulated from the first electrodes and have openings. An insulating layer has openings communicating with the openings of the second electrodes. A third electrode is placed over the second electrodes and electrically insulated from the second electrodes by the insulating layer. The third electrode has openings communicating with the openings of the second electrodes and the openings of the insulating layer. Phosphor layers are placed on one surface of the second substrates. A fourth electrode is placed on one surface of the phosphor layers. The second electrodes, the insulating layer and the third electrode have openings exposing the electron emission regions and communicating with each other. The second electrodes and the insulating layer are structured to simultaneously satisfy the following condition:
1<W4/W3≦2 (2)
W5<W3 (3)

where W3 indicates the bottom width of each opening of the insulating layer, W4 the top width of each opening of the insulating layer, and W5 the width of each opening of the second electrodes.

Furthermore, the second electrodes and the insulating layer may be structured to satisfy the following conditions:
W4≦3×W5. (4)

The opening of the third electrode may have the same width as the top width of the insulating layer.

According to another exemplary embodiment the present invention, an electron emission display includes a light emission unit and an electron emission unit facing the light emission unit. The electron emission unit includes a first substrate, first electrodes formed on the first substrate, electron emission regions electrically connected to the first electrodes, second electrodes placed over the first electrodes, the second electrodes electrically insulated from the first electrodes, the second electrodes have openings, an insulating layer formed on the second electrodes, the insulating layer having openings communicating with the openings of the second electrodes, and a third electrode formed on the top of the insulating layer, the third electrode having openings communicating with the openings of the second electrodes and the openings of the insulating layer, the openings of the third electrode having the same width as a top width of the opening of the insulating layer,

the openings of the second electrodes, the insulating layer and the third electrode exposing the electron emission regions and structured to satisfy one of the following conditions: (i) W3/W4=1 and 1.5≦W4/W5≦3.0; and (ii) 1<W4/W3≦2 and W5<W3 where W3 indicates the bottom width of each opening of the insulating layer, W4 indicates the top width of each opening of the insulating layer, and W5 indicates the width of each opening of the second electrode.

### BRIEF DESCRIPTION OF THE DRAWINGS

A more complete appreciation of the present invention, and many of the above and other features and advantages of the present invention, will be readily apparent as the same becomes better understood by reference to the following detailed description when considered in conjunction with the accompanying drawings in which like reference symbols indicate the same or similar components, wherein:

FIG. 1 is a partial exploded perspective view of an electron emission display according to a first embodiment of the present invention;

FIG. 2 is a partial sectional view of the electron emission display according to the first embodiment of the present invention;

FIG. 3 is a graph illustrating the variation in size of the main electron beams as a function of the variation in W2/W1 with the electron emission display according to the first embodiment of the present invention;

FIG. 4 is a graph illustrating the variation in size of the secondary electron beams as a function of the variation in W2/W1 with the electron emission display according to the first embodiment of the present invention;

FIG. 5 is a partial plan view of an electron emission unit of an electron emission display according to a second embodiment of the present invention;

FIG. 6 is a partial exploded perspective view of an electron emission display according to a third embodiment of the present invention;

FIG. 7 is a partial sectional view of the electron emission display according to the third embodiment of the present invention;

FIG. 8 is an amplified photograph of an electron beam spot observed in relation to Comparative Example 1 of the electron emission display;

FIG. 9 is an amplified photograph of an electron beam spot observed in relation to Comparative Example 3 with the electron emission display;

FIG. 10 is an amplified photograph of an electron beam spot observed in relation to Example 2 with the electron emission display according to the third embodiment of the present invention;

FIG. 11 is an amplified photograph of an electron beam spot observed in relation to Example 3 with the electron emission display according to the third embodiment of the present invention;

FIG. 12 is an amplified photograph of an electron beam spot observed in relation to Example 6 with the electron emission display according to the third embodiment of the present invention;

FIG. 13 is an amplified photograph of an electron beam spot observed in relation to Example 7 with the electron emission display according to the third embodiment of the present invention; and

FIG. 14 is a partial plan view of an electron emission unit of an electron emission display according to a fourth embodiment of the present invention.

### DETAILED DESCRIPTION OF PREFERRED EMBODIMENTS

The present invention will be described more fully hereinafter with reference to the accompanying drawings, in which preferred embodiments of the invention are shown.

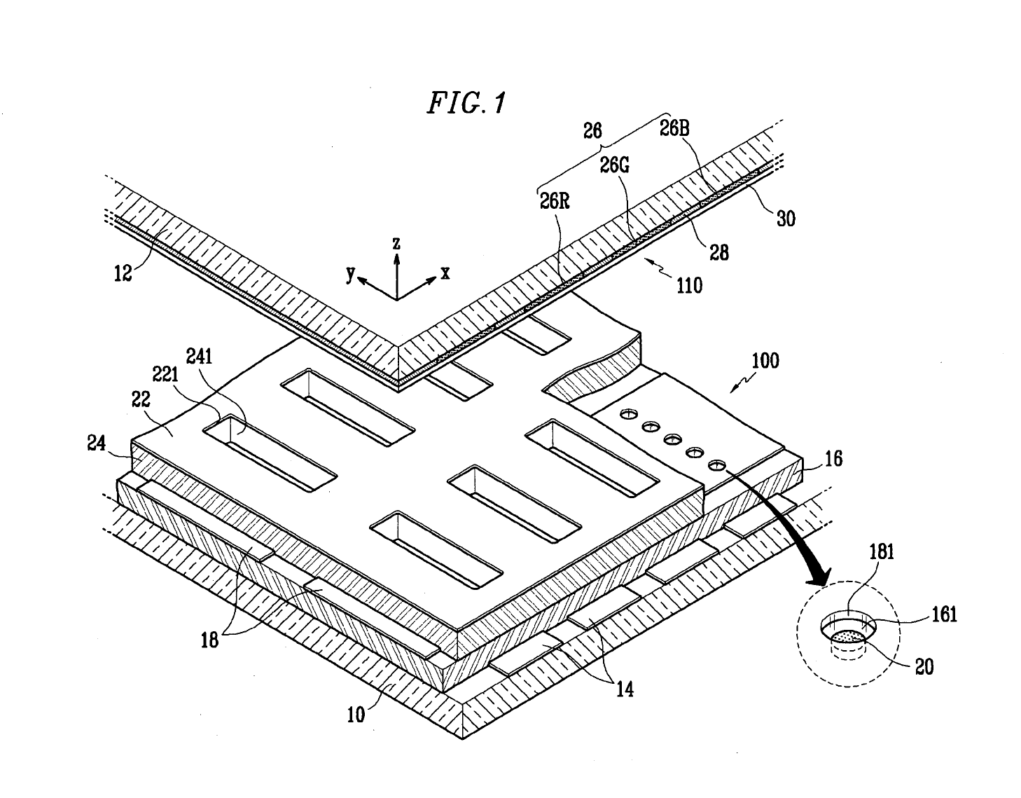

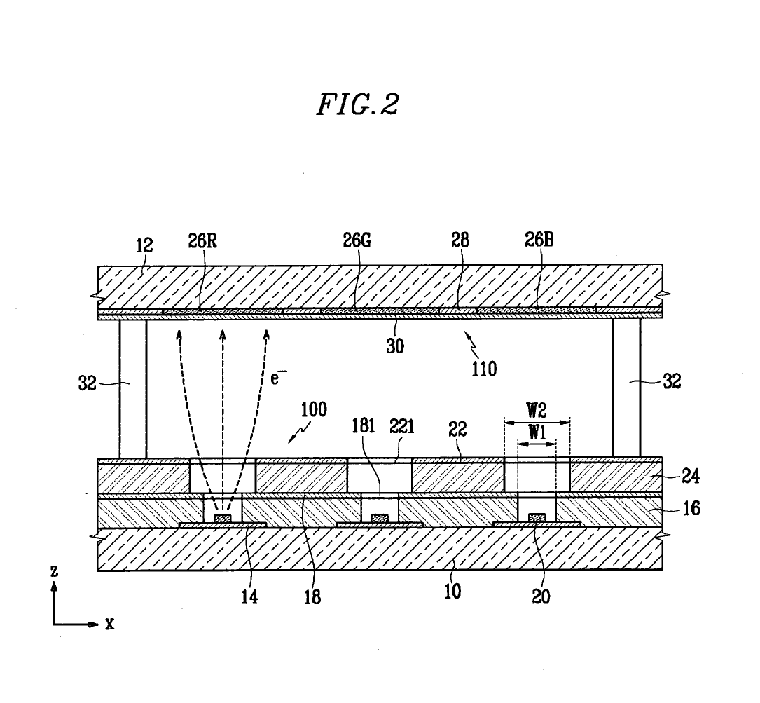

FIGS. 1 and 2 are a partial exploded perspective view and a partial sectional view of an electron emission display according to a first embodiment of the present invention.

As shown in FIGS. 1 and 2, the electron emission display includes first and second substrates 10 and 12 facing each other in parallel with a predetermined distance. A sealing member (not shown) is provided at the peripheries of the first and the second substrates 10 and 12 to seal them, and the internal space between the two substrates 10 and 12 is evacuated to be at 10⁻⁶ Torr, thereby constructing a vacuum vessel with the first and the second substrates 10 and 12 and the sealing member.

An electron emission unit 100 with electron emission elements is provided on a surface of the first substrate 10 facing the second substrate 12, and a light emission unit 110 is provided on a surface of the second substrate 12 facing the first substrate 10 to emit visible rays due to the electrons.

The electron emission unit 100 will be first explained. Cathode electrodes 14 are stripe-patterned on the first substrate 10 in a direction thereof as the first electrodes, and a first insulating layer 16 is formed on the entire surface of the first substrate 10 such that it covers the cathode electrodes 14. Gate electrodes 18 are stripe-patterned on the first insulating layer 16 as the second electrodes such that they cross the cathode electrodes 14.

When the crossed regions of the cathode and the gate electrodes 14 and 18 are defined as pixel regions, electron emission regions 20 are formed on the cathode electrodes 14 at the respective pixels, and openings 161 and 181 are formed at the first insulating layer 16 and the gate electrodes 18 corresponding to the respective electron emission regions 20 such that the electron emission regions 20 are exposed on the first substrate 10.

The electron emission regions 20 may be formed with a material emitting electrons when an electric field is applied thereto under a vacuum atmosphere, such as a carbonaceous material and a nanometer (nm)-sized material. For instance, the electron emission regions 20 may be formed with carbon nanotube, graphite, graphite nanofiber, diamond, diamond-like carbon, fullerene C₆₀, silicon nanowire, or a combination thereof. The formation of the electron emission regions 20 may be made by screen printing, direct growth, chemical vapor deposition, or sputtering.

Alternatively, the electron emission regions may be formed with a sharp-pointed tip structure mainly based on molybdenum (Mo) or silicon (Si).

FIG. 1 illustrates a structure where the electron emission regions 20 are formed in the shape of a circle, and linearly arranged in the longitudinal direction of the cathode electrodes 14 at the respective pixels. However, the plane shape, number per pixel and arrangement of the electron emission regions 20 are not limited to the illustrated, but may be altered in various manners.

A focusing electrode 22 is formed on the gate electrodes 18 and the first insulating layer 16 as the third electrode. A second insulating layer 24 is placed under the focusing electrode 22 to insulate the gate electrodes 18 and the focusing electrode 22 from each other, and openings 241 and 221 through which the electron beams pass are formed at the second insulating layer 24 and the focusing electrode 22. In this embodiment, the openings 241 and 221 are formed at the respective pixels one by one to simultaneously expose the electron emission regions 20 placed at each pixel. In other words, each one of the openings 241 and 221 are formed at the respective pixels.

The light emission unit 110 will be now explained. Phosphor layers 26 with red, green and blue phosphor layers 26R, 26G and 26B are formed on a surface of the second substrate 12 such that they are spaced apart from each other with a distance, and a black layer 28 is formed between the respective phosphor layers 26 to enhance the screen contrast.

The phosphor layers 26 are arranged at the respective crossed regions of the cathode and the gate electrodes 14 and 18 such that one of the three-colored phosphor layers 26R, 26G and 26B corresponds to each crossed region thereof. For example, the red, green and blue phosphor layers 26R, 26G and 26B are alternately arranged in the longitudinal direction of the gate electrodes 18, and the same-colored phosphor layers 26 are arranged in parallel along the length of the cathode electrodes 14.

An anode electrode 30 is formed on the phosphor layers 26 and the black layers 28 with a metallic material such as aluminum (Al). The anode electrode 30 receives a high voltage required for accelerating the electron beams to make the phosphor layers 26 be in a high potential state, and reflects the visible rays to be radiated from the phosphor layers 26 to the first substrate 10 toward the second substrate 12 to heighten the screen luminance.

Alternatively, the anode electrode may be formed with a transparent conductive material such as indium tin oxide (ITO). In this case, the anode electrode is placed on a surface of the phosphor and the black layers 26 and 28 directed toward the second substrate 12. It is also possible that the metallic layer and the transparent conductive layer are simultaneously formed to function as the anode electrode.

As shown in FIG. 2, spacers 32 are arranged between the first and the second substrates 10 and 12 to endure the pressure applied to the vacuum vessel and sustain the distance between the two substrates constantly. The spacer 32 is placed at the area of the black layer 28 such that it does not intrude upon the area of the phosphor layer 26.

In order to drive the above-structured electron emission display, predetermined voltages are applied to the cathode electrodes 14, the gate electrodes 18, the focusing electrode 22 and the anode electrode 30 from the outside.

For instance, any one of the cathode and the gate electrodes 14 and 18 receives a scan driving voltage to function as a scan electrode, and the other electrode receives a data driving voltage to function as a data electrode. The focusing electrode 22 receives a voltage required for focusing the electron beams, such as 0V or a negative direct current voltage of several to several tens volts, and the anode electrode 30 receives a voltage required for accelerating the electron beams, such as a positive direct current voltage of several hundreds to several thousands volts.

Electric fields are then formed around the electron emission regions 20 at the pixels where the voltage difference between the cathode and the gate electrodes 14 and 18 exceeds the threshold value, and electrons are emitted from those electron emission regions 20. The emitted electrons pass through the openings 221 of the focusing electrode 22, and are focused to the centers of the bundles of electron beams. The electrons are then attracted by the high voltage applied to the anode electrode 30, and collide against the phosphor layers 26 at the relevant pixels to excite them and emit light.

With the above-described driving process, among the bundles of electron beams landed on the phosphor layers 26 are there secondary electron beams having a diameter larger than that of the main electron beams and an intensity weaker than that of the main electron beams. The secondary electron beams mainly refer to the electrons over-focused by the focusing electrode 22 and deviated from the main electron beams.

With the above structure, the width ratio of the opening 221 of the focusing electrode 22 to the opening 181 of the gate electrode 18 becomes to be a critical factor for determining the sizes of the main and the secondary electron beams. In this embodiment, the gate electrodes 18 and the focusing electrode 22 are structured to satisfy the following condition:
1.5≦W2/W1≦3.0 (1)

where W1 indicates the width of the opening 181 of the gate electrode 18, and W2 indicates the width of the opening 221 of the focusing electrode 22. The widths of W1 and W2 are measured in the direction where the different-colored phosphor layers 26 are arranged neighboring to each other (in the x axis direction of the drawing), which commonly agrees to the horizontal direction of the screen.

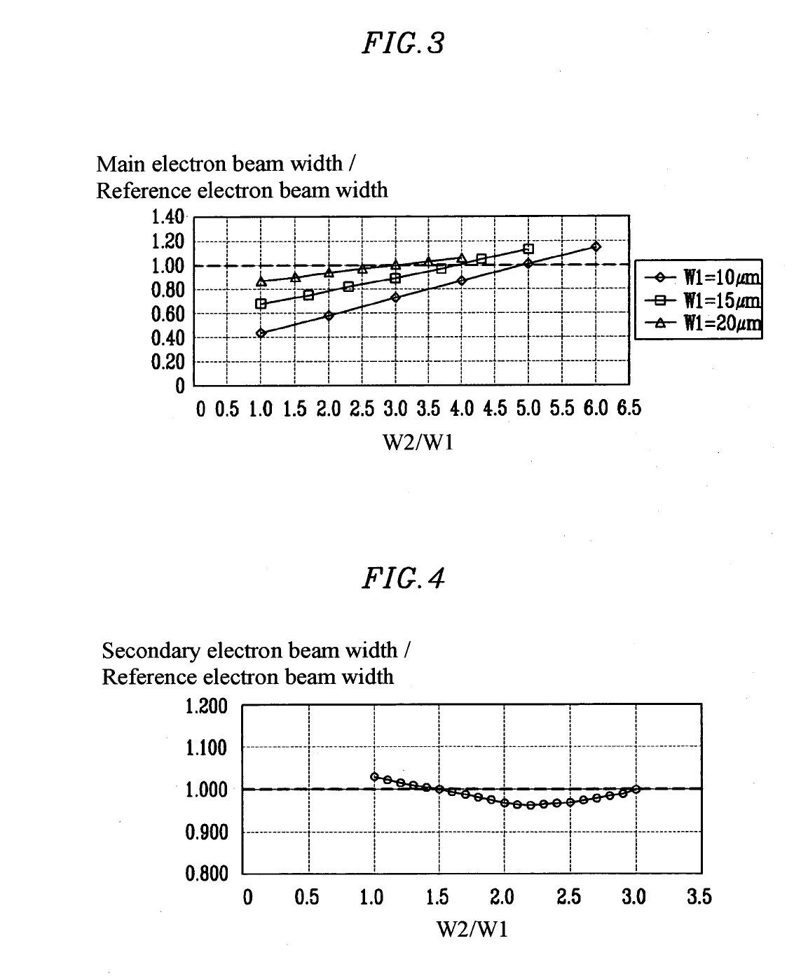

FIG. 3 is a graph illustrating the variation in size of the main electron beams as a function of the variation in W2/W1, and FIG. 4 is a graph illustrating the variation in size of the secondary electron beams as a function of the variation in W2/W1.

As shown in FIGS. 3 and 4, the widths of the main electron beams and the secondary beams are estimated by the ratio thereof to the width of the reference electron beam. The width of the reference electron beam is obtained by multiplying the horizontal pitch of the pixel multiplied by ⅓, and when the electron beams are formed with a width larger than that of the reference electron beam, they are liable to hit the incorrect color phosphor layers. The widths of the reference electron beam, the main electron beam and the secondary electron beam are measured in the direction where W1 and W2 are defined.

As shown in FIG. 3, in case the width W1 of the opening of the gate electrode was varied to be 10 μm, 15 μm and 20 μm, the width W2 of the opening of the focusing electrode was altered to check the variation in size of the main electron beams.

As a result, the width ratio of the main electron beam to the reference electron beam was differentiated depending upon the width W1 of the openings of the gate electrodes. However, when W2/W1 was 3.0 or less, the width of the main electron beam was smaller than that of the reference electron beam in all the three cases, and the hitting of the incorrect color phosphor layers was not made.

With the common electron emission display, the secondary electron beam is enlarged as the size of the main electron beam is reduced. When the main electron beam is reduced and the secondary electron beam is enlarged, the light emission uniformity of the phosphor layers is deteriorated, and the color purity is deteriorated due to the hitting of the incorrect color phosphor layers. Accordingly, the width of the secondary electron beam should be kept not to exceed the width of the reference electron beam.

As shown in FIG. 4, when the width W1 of the opening of the gate electrode was 20 μm, the width W2 of the opening of the focusing electrode was altered to check the variation in size of the secondary electron beam. It turned out that when the ratio of W2/W1 was in the range of 1.5-3, the secondary electron beam had a width smaller than that of the reference electron beam.

In this connection, the gate electrodes 18 and the focusing electrode 22 are structured to satisfy the condition of the formula 1. With the electron emission display according to the present embodiment satisfying that condition, the hitting of the incorrect color phosphor layers due to the spreading of the electron beams is prevented, thereby heightening the screen color purity.

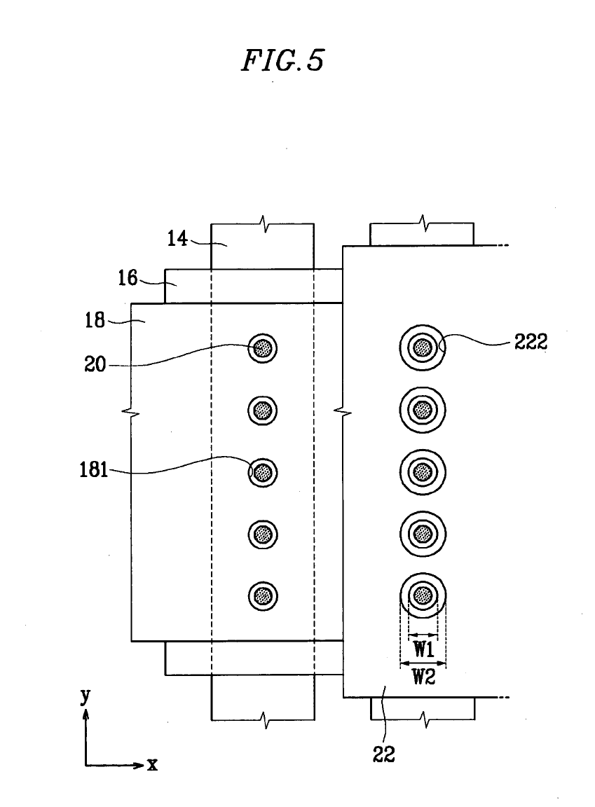

FIG. 5 is a partial plan view of an electron emission unit of an electron emission display according to a second embodiment of the present invention.

The electron emission display according to the present embodiment has the same structural components as those related to the first embodiment except that the focusing electrode 22 has openings 222 corresponding to the respective electron emission regions 20 one by one. In other words, each one of the openings 222 are formed over the respective openings 181 of the gate electrode 18.

The focusing electrode 22 separately focuses the electrons emitted from the electron emission regions 20. That is, the focusing electrode 20 effectively focuses the electron beams spread in the longitudinal direction of the cathode electrode 14 (in the y axis direction of the drawing) as well as in the width direction of the cathode electrode 14 (in the x axis direction of the drawing), thereby reducing all the horizontal and the vertical diameters of the electron beams.

It is illustrated in the drawing that the electron emission regions 20, the openings 181 of the gate electrodes 18 and the openings 222 of the focusing electrode 22 are formed in the shape of a circle, but the plane shape thereof may be varied to be a rectangle, an oval, a track, etc.

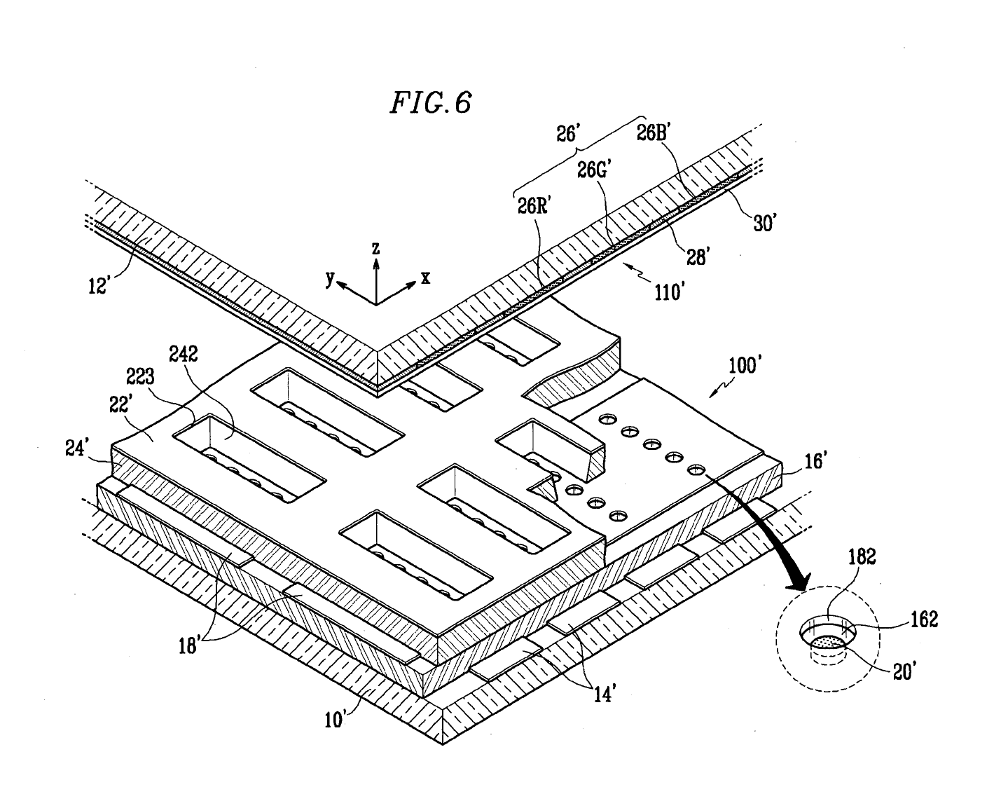

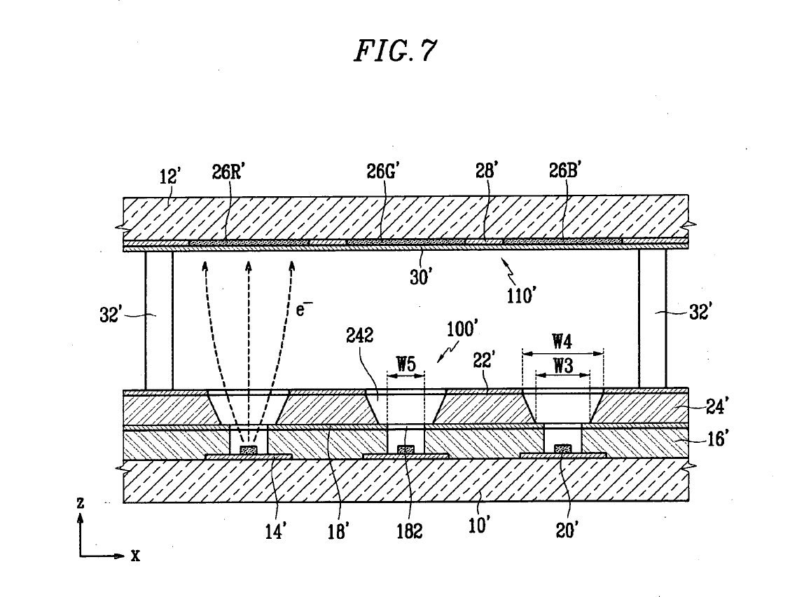

FIGS. 6 and 7 are a partial exploded perspective view and a partial sectional view of an electron emission display according to a third embodiment of the present invention.

As shown in FIGS. 6 and 7, with the electron emission display according to the present embodiment, the width of the opening 242 becomes enlarged as the second insulating layer 24′ goes far from the first substrate 10′. That is, when the second insulating layer 24′ is viewed from the sectional perspective, the sidewall of the opening 242 of the second insulating layer 24′ inclines with a predetermined inclination.

The opening 182 of the gate electrode 18′ has a width smaller than the bottom width of the opening 242 of the second insulating layer 24′ such that the top surface of the gate electrode 18′ is partially exposed through the opening 242 of the second insulating layer 24′. It is illustrated in FIG. 6 that each one of the openings 223 of the focusing electrode 22′ is arranged at the respective pixels.

With the above structure, when electrons are emitted from the electron emission regions 20′, the number of electrons collided against the sidewall of the opening 242 of the second insulating layer 24′ is reduced, thereby preventing the electric charging of the second insulating layer 24′ due to the collision of electrons. The width of the opening 223 of the focusing electrode 22′ may be the same as or larger than the top width of the opening 242 of the second insulating layer 24′. When the width of the opening 223 of the focusing electrode 22′ is the same as the top width of the opening 242 of the second insulating layer 24′, the electron beam focusing efficiency can be heightened.

In this embodiment, the second insulating layer 24′ is structured to satisfy the following conditions:
1<W4/W3≦2 (2)
W5<W3 (3)

where W3 indicates the bottom width of the opening 242 of the second insulating layer 24′ measured on the bottom surface of the second insulating layer 24′, W4 the top width of the opening 242 of the second insulating layer 24′ measured on the top surface of the second insulating layer 24′, and W5 the width of the opening 182 of the gate electrode 18′.

The widths of W3, W4 and W5 are measured in the direction where the different-colored phosphor layers are arranged neighboring to each other (in the x axis direction of the drawing), which commonly agrees to the horizontal direction of the screen.

Tables 1 and 2 list the measurement results of the horizontal width of the electron beam and the color representation ratio and the luminance variation when the top width W4 of the opening 242 of the second insulating layer 24′ is varied while fixing the width W5 of the opening 182 of the gate electrode 18 and the bottom width W3 of the opening 242 of the second insulating layer 24′.

The measurement results listed in Table 1 were obtained from the experiments where the top width W4 of the opening 242 of the second insulating layer 24′ was varied to be 30 μm, 40 μm, 50 μm, 60 μm and 70 μm while establishing the bottom width W3 of the opening 242 of the second insulating layer 24′ to be 30 μm. The measurement results listed in Table 2 were obtained from the experiments where the top width W4 of the opening 242 of the second insulating layer 24′ was varied to be 40 μm, 50 μm, 60 μm, 70 μm, 80 μm and 90 μm while establishing the bottom width W3 of the opening 242 of the second insulating layer 24′ to be 40 μm.

The above experiments were conducted while applying the driving voltages such that the emission current density was kept to be 0.0304 A/m′ in all the test items. The anode electric field was established to be 3.33 V/μm, the horizontal width of the phosphor layer to be 150 μm, the target color representation ratio to be 55%, and the target luminance to be 400 cd/m′.

TABLE 1

| | Com. Ex. 1 | Ex. 1 | Ex. 2 | Ex. 3 | Com. Ex. 2 |
|---|---|---|---|---|---|
| W5 (μm) | 15 | | | | |
| W3 (μm) | 30 | | | | |
| W4 (μm) | 30 | 40 | 50 | 60 | 70 |
| Horizontal | 200 (Main | 225 | 255 | 280 | 350 |
| width of | electron | | | | |
| electron beam | beam) | | | | |
| (μm) | | | | | |
| Color | 54% | 64% | 65% | 65% | 50% |
| representation | | | | | |
| ratio | | | | | |
| (compared to | | | | | |
| NTSC) | | | | | |
| Luminance (cd/m²) | 450 | 425 | 415 | 400 | 300 |
| Incidental light | Little | No | No | No | No |

TABLE 2

| | Com. | | | | | |
|---|---|---|---|---|---|---|
| | Ex. 3 | Ex. 4 | Ex. 5 | Ex. 6 | Ex. 7 | Com. Ex. 4 |
| W5 (μm) | 15 | | | | | |
| W3 (μm) | 40 | | | | | |
| W4 (μm) | 40 | 50 | 60 | 70 | 80 | 90 |
| Horizontal width | 230 (Main | 250 | 275 | 295 | 310 | 340 |
| of electron | electron | | | | | |
| beam (μm) | beam) | | | | | |
| Color | 52% | 63% | 64% | 65% | 65% | 52% |
| representation | | | | | | |
| ratio (compared | | | | | | |
| to NTSC) | | | | | | |
| Luminance | 445 | 430 | 410 | 405 | 400 | 315 |
| (cd/m²) | | | | | | |
| Incidental light | Little | No | No | No | No | No |
| emission | | | | | | |

It is known from the Tables 1 and 2 that with the Comparative Examples 1 and 3 where the bottom width W3 and the top width W4 of the opening 242 of the second insulating layer 24′ were the same, the electron beams landed on the phosphor layers were factored into main and secondary electron beams. The horizontal width of the main electron beam of Comparative Example 1 was smaller than the horizontal width of the electron beam of the Examples 1-3, and the horizontal width of the main electron beam of Comparative Example 3 was smaller than the horizontal width of the electron beam of the Examples 4-7. These results were obtained due to the phenomenon where the sidewall of the opening of the second insulating layer was charged due to the collision of electrons to thereby distort the trajectories of the electron beams.

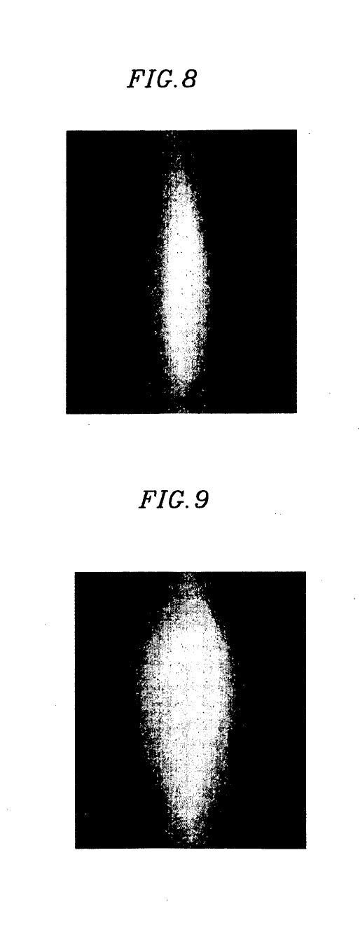

FIG. 8 is an amplified photograph of the electron beam spot observed in relation to the Comparative Example 1, and FIG. 9 is an amplified photograph of the electron beam spot observed in relation to the Comparative Example 3.

As shown in FIGS. 8 and 9, with the Comparative Examples 1 and 3, secondary electron beams were generated external to the main electron beams with an intensity weaker than that of the main electron beams. The secondary electron beams induces an incidental light emission, and deteriorates the light emission uniformity of the phosphor layers and the color representation ratio.

As listed in the Tables 1 and 2, with the Examples 1 to 7 where the condition of the formula 2 was satisfied, any secondary electron beams were not generated at the electron beam spots landed on the phosphor layers, and the horizontal width of the electron beams was enlarged.

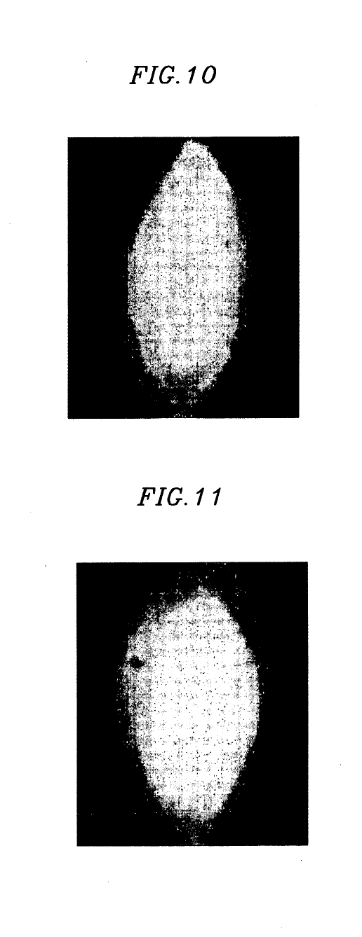

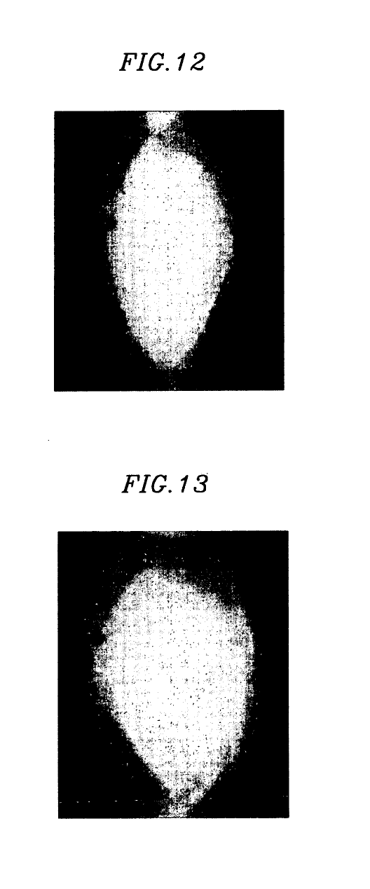

FIGS. 10 and 11 are amplified photographs of the electron beam spots observed in relation to the Examples 2 and 3, and FIGS. 12 and 13 are amplified photographs of the electron beam spots observed in relation to the Examples 6 and 7.

As shown in FIGS. 10 to 13, with the Examples 2, 3, 6 and 7, the secondary beams were not generated, and the horizontal width of the electron beams was enlarged compared to that of the Comparative Examples 1 and 3. Consequently, with the Examples where the condition of the formula 2 was satisfied, the incidental light emission due to the secondary electron beams was not made, and the color representation ratio and the luminance reached the target values, respectively.

As known from the Tables 1 and 2, with the Comparative Examples 2 and 4 where the top width of the opening of the second insulating layer was two times larger than the bottom width thereof, the horizontal width of the electron beams landed on the phosphor layers was overly enlarged so that the luminance and the color representation was lowered. This result was made due to the phenomenon where the opening of the focusing electrode was overly enlarged so that the electron beam focusing efficiency was deteriorated.

As described above, with the electron emission display according to the present embodiment where the condition of the formula 2 is satisfied, the electric charging of the sidewall of the opening 242 of the second insulating layer is prevented to thereby minimize the incidental light emission due to the electric charging. Consequently, the target luminance value is obtained, and the color representation ratio of the phosphor layers 26′ is heightened.

Furthermore, with the electron emission display according to the present embodiment, considering the experimental results related to the first embodiment, the gate electrodes 18′ and the second insulating layer 24′ may be structured to further satisfy the following condition:
W4≦3W5 (4).

To simply the Formulae (1) to (4), Formula (1) may be expressed with W3, W4 and W5 when the width of the opening 221 of the focus electrode 22 is the same as the top width of the opening of the second insulating layer 24 in the first embodiment. In this case, Formula (1) can be expressed as W4/W3=1 and 1.5≦W4/W5≦3.0.

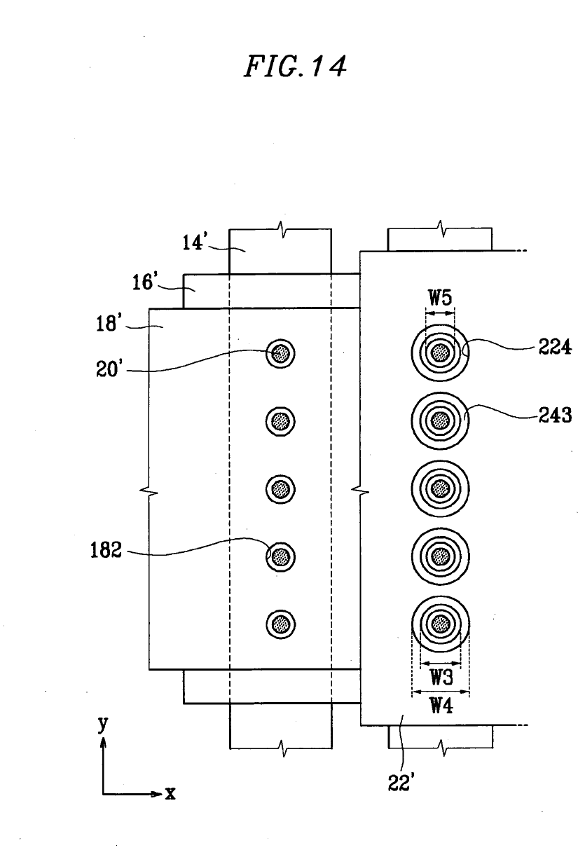

FIG. 14 is a partial plan view of an electron emission unit of an electron emission display according to a fourth embodiment of the present invention.

The electron emission display has the same structural components as those related to the third embodiment except that the focusing electrode 22′ has openings 224 each arranged at the respective electron emission regions 20′.

The focusing electrode 22′ separately focuses the electrons emitted from the electron emission regions 20′, and hence, the electron beams spread in the longitudinal direction of the cathode electrode 14′ (in the y axis direction of the drawing) as well as in the width direction of the cathode electrode 14′ (in the x axis direction of the drawing) are focused effectively, thereby reducing the horizontal and the vertical diameters of the electron beams.

It is illustrated in the drawing that the electron emission regions 20′, the openings 182 of the gate electrodes 18′ and the openings 224 of the focusing electrode 22′ are formed in the shape of a circle, but the plane shape thereof may be varied to be a rectangle, an oval, a track, etc.

Although preferred embodiments of the present invention have been described in detail hereinabove, it should be clearly understood that many variations and/or modifications of the basic inventive concept herein taught which may appear to those skilled in the art will still fall within the spirit and scope of the present invention, as defined in the appended claims.

What is claimed is:

1. An electron emission display, comprising:
first and second substrates facing each other;
first electrodes formed on the first substrate;
electron emission regions electrically connected to the first electrodes;
second electrodes placed over the first electrodes, the second electrodes electrically insulated from the first electrodes, the second electrodes having a plurality of openings for exposing the electron emission regions;
a third electrode placed over the second electrodes, the third electrode electrically insulated from the second electrodes, the third electrode having openings communicating with the openings of the second electrodes, the openings of the second electrodes and the openings of the third electrode structured to satisfy the following condition:
1.5≦W2/W1≦3.0 (1)
where W1 indicates the width of each opening of the second electrodes, and W2 indicates the width of each opening of the third electrode;
phosphor layers placed on one surface of the second substrate; and
a fourth electrode placed on one surface of the phosphor layers.

2. The electron emission display of claim 1, wherein the phosphor layers comprise red, green and blue phosphor layers arranged in a direction of the substrates neighboring to each other, and the widths of W1 and W2 are measured in the direction of the substrates.

3. The electron emission display of claim 1, wherein the first and the second electrodes cross each other, the electron emission regions, the openings of the second electrodes and the openings of the third electrode are arranged at the crossed regions of the first and the second electrodes, and the respective openings of the second electrodes at each crossed region are arranged in a row in the longitudinal direction of the first electrodes.

4. The electron emission display of claim 3, wherein each one of the openings of the third electrode is arranged at the respective crossed regions.

5. The electron emission display of claim 3, wherein each one of the openings of the third electrode are arranged over the respective openings of the second electrodes.

6. The electron emission display of claim 3, wherein the widths of W1 and W2 are measured in the width direction of the first electrodes.

7. The electron emission display of claim 1, wherein the electron emission regions comprise one of a carbonaceous material and a nanometer-sized material.

8. An electron emission display comprising:
first and second substrates facing each other;
first electrodes formed on the first substrate;
electron emission regions electrically connected to the first electrodes;
second electrodes placed over the first electrodes, the second electrodes electrically insulated from the first electrodes, the second electrodes have openings;
an insulating layer having openings communicating with the openings of the second electrodes;
a third electrode placed over the second electrodes, the third electrode electrically insulated from the second electrodes by the insulating layer, the third electrode having openings communicating with the openings of the second electrodes and the openings of the insulating layer, the openings of the second electrodes, the insulating layer and the third electrode exposing the electron emission regions and structured to satisfy the following conditions:
1<W4/W3≦2 (2)
W5<W3 (3)
where W3 indicates the bottom width of each opening of the insulating layer, W4 indicates the top width of each opening of the insulating layer, and W5 indicates the width of each opening of the second electrode;
phosphor layers placed on one surface of the second substrates; and
a fourth electrode placed on one surface of the phosphor layers.

9. The electron emission display of claim 8, wherein the phosphor layers comprise red, green and blue phosphor layers arranged in a direction of the substrates neighboring to each other, and the widths of W3, W4 and W5 are measured in the direction of the substrates.

10. The electron emission display of claim 9, wherein the second electrodes and the insulating layer are structured to satisfy the following condition:
W4≦3×W5 (4).

11. The electron emission display of claim 8, wherein the opening of the third electrode has the same width as the top width of the opening of the insulating layer.

12. The electron emission display of claim 8, wherein the first and the second electrodes cross each other, the electron emission regions, the openings of the second electrodes and the openings of the third electrode are arranged at the crossed regions of the first and the second electrodes, and the respective openings of the second electrodes at each crossed region are arranged in a row in the longitudinal direction of the first electrodes.

13. The electron emission display of claim 12, wherein each one of the openings of the third electrode is arranged at the respective crossed regions.

14. The electron emission display of claim 12, wherein the openings of the third electrode are arranged in one to one correspondence with the openings of the second electrodes.

15. The electron emission display of claim 12, wherein the widths of W1 and W2 are measured in the width direction of the first electrodes.

16. The electron emission display of claim 8, wherein the electron emission regions comprise one of a carbonaceous material and a nanometer-sized material.

17. An electron emission display, comprising:
a light emission unit; and
an electron emission unit facing the light emission unit, the electron emission unit comprising;
a first substrate;
first electrodes formed on the first substrate;
electron emission regions electrically connected to the first electrodes;
second electrodes placed over the first electrodes, the second electrodes electrically insulated from the first electrodes, the second electrodes have openings;
an insulating layer formed on the second electrodes, the insulating layer having openings communicating with the openings of the second electrodes; and
a third electrode formed on the top of the insulating layer, the third electrode having openings communicating with the openings of the second electrodes and the openings of the insulating layer, the openings of the third electrode having the same width as a top width of the opening of the insulating layer, the openings of the second electrodes, the insulating layer and the third electrode exposing the electron emission regions and structured to satisfy one of the following conditions:
(i) W3/W4=1 and 1.5≦W4/W5≦3.0; and
(ii) 1<W4/W3≦2 and W5<W3
where W3 indicates the bottom width of each opening of the insulating layer, W4 indicates the top width of each opening of the insulating layer, and W5 indicates the width of each opening of the second electrode.

18. The electron emission display of claim 17, wherein the second electrodes and the insulating layer are structured to satisfy the following condition:
1<W4/W3≦2, W5<W3, and W4≦3×W5.

19. The electron emission display of claim 17, wherein each one of the openings of the third electrode is arranged at the respective crossed regions.

20. The electron emission display of claim 17, wherein the openings of the third electrode are arranged in one to one correspondence with the openings of the second electrodes.
